(19) United States
(12) Patent Application Publication
(10) Pub. No.: US 2025/0150336 A1
(43) Pub. Date: May 8, 2025

(54) DATA PROCESSING APPARATUS, METHOD, AND PROGRAM

(71) Applicant: NIPPON TELEGRAPH AND TELEPHONE CORPORATION, Tokyo (JP)

(72) Inventors: Hiroaki KIKUSHIMA, Musashino-shi (JP); Shingo HORIUCHI, Musashino-shi (JP); Chao WU, Musashino-shi (JP); Nobukazu FUKUDA, Musashino-shi (JP)

(73) Assignee: NIPPON TELEGRAPH AND TELEPHONE CORPORATION, Tokyo (JP)

(21) Appl. No.: 18/837,243

(22) PCT Filed: Feb. 21, 2022
(86) PCT No.: PCT/JP2022/006980

§ 371 Date: Aug. 9, 2024

(51) Int. Cl. H04L 41/0806; H04L 41/5054

(52) U.S. Cl. CPC H04L 41/0806; H04L 41/5054

(57) ABSTRACT

A data processing apparatus according to one embodiment includes: an input unit that receives an input related to a situation when a user who uses a service uses the service; a storage device that stores information indicating a relationship between a situation when the service is used and a requirement related to provision of the service to the user; and a calculation unit that calculates a requirement related to provision of the service to the user on the basis of a result of input by the input unit and the information stored in the storage device.

### TECHNICAL FIELD

Embodiments of the present invention relate to a data processing apparatus, a method, and a program.

### BACKGROUND ART

In the field of automatic control of a network service such as an autonomous network (autonomous NW) or an application service such as software as a service (Saas) (hereinafter, the services may be collectively referred to simply as a service), resource control or failure countermeasures for providing a service that satisfies an intent (intent or purpose of a user (sometimes referred to as a customer)) have attracted attention.

### Citation List

### Non Patent Literature

Non Patent Literature 1: Aaron Richard Earl Boasman-Patel, et, al. “Autonomous Networks: Empowering Digital Transformation For The Telecoms Industry”, A whitepaper Release 1.0, 15 May 2019, tm forum.

### SUMMARY OF INVENTION

### Technical Problem

However, at present, an intent quantified to some extent needs to be directly input to a resource control system, and for this purpose, intervention of a technician familiar with the system, creation of a rule base in advance, and the like are essential.

Therefore, it is necessary to perform maintenance according to a change in a service provision situation, and cost and lack of flexibility related to the maintenance are problems. In addition, it is difficult to implement the creation of the rule base by machine learning because there is no data set. That is, at present, it is difficult to provide an appropriate service based on a service use requirement of a user.

The present invention has been made in view of the above circumstances, and an object thereof is to provide a data processing apparatus, a method, and a program capable of providing appropriate service based on a service use equipment of a user.

### Solution to Problem

A data processing apparatus according to one aspect of the present invention includes: an input unit that receives an input related to a situation when a user who uses a service uses the service; a storage device that stores information indicating a relationship between a situation when the service is used and a requirement related to provision of the service to the user; and a calculation unit that calculates a requirement related to provision of the service to the user on the basis of a result of input by the input unit and the information stored in the storage device.

A data processing method according to one aspect of the present invention is a method performed by a data processing apparatus including a storage device that stores information indicating a relationship between a situation when a service is used and a requirement related to provision of the service to a user who uses the service, the method including: receiving, by an input unit of the data processing apparatus, an input related to a situation when the user who uses the service uses the service; and calculating, by a calculation unit of the data processing apparatus, a requirement related to provision of the service to the user on the basis of a result of input by the input unit and the information stored in the storage device.

### Advantageous Effects of Invention

According to the present invention, it is possible to provide an appropriate service based on a service use requirement of a user.

### BRIEF DESCRIPTION OF DRAWINGS

FIG. 1 is a diagram illustrating an application example of a data processing apparatus according to one embodiment of the present invention.

FIG. 2 is a diagram illustrating a specific example of information handled by each unit of the data processing apparatus according to the one embodiment of the present invention and a configuration of the data processing apparatus.

FIG. 3 is a diagram for describing an example of a procedure of processing by the data processing apparatus according to the one embodiment of present invention.

FIG. 4 is a diagram illustrating an example of information handled in the processing by the data processing apparatus according to the one embodiment of the present invention.

FIG. 5 is a block diagram illustrating an example of a hardware configuration of the data processing apparatus according to the one embodiment of the present invention.

### DESCRIPTION OF EMBODIMENTS

Hereinafter, one embodiment according to the present invention will be described with reference to the drawings.

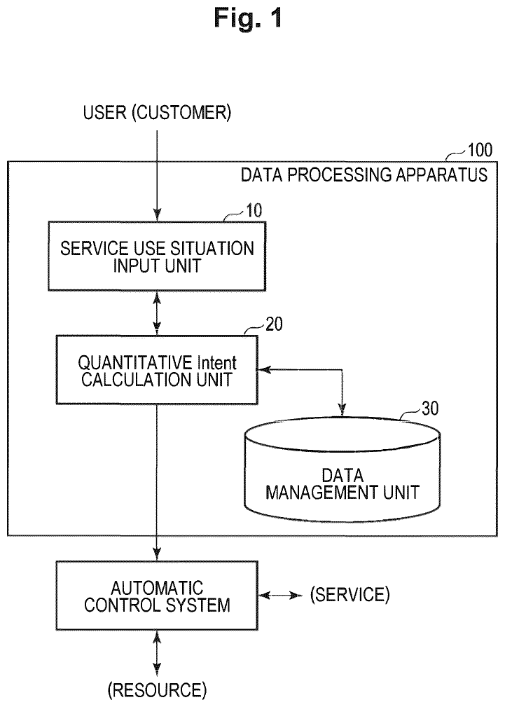

FIG. 1 is a diagram illustrating an application example of a data processing apparatus according to the one embodiment of the present invention.

As illustrated in FIG. 1, data processing apparatus 100 according to the one embodiment of the present invention includes a service use situation input unit 10, a quantitative intent calculation unit 20, and a data management unit 30.

The situation use situation input unit 10 receives an input of a service situation (which may be referred to as a use requirement) related to a network service or an application service by a user's operation on an input/output interface (not illustrated).

The data management unit 30 is provided with a storage device, and the storage device stores (stores) data models and ontologies that are defined in a distributed manner and used to calculate a quantitative intent, which is a intent that is quantitative.

The quantitative intent calculation unit 20 calculates a quantitative intent on the basis of the input result by the service use situation input unit 10 and the data models in the data management unit 30, and passes the calculation result to an external automatic control system. The automatic control system can perform control of service contents related to the network service or the application service and resource control on basis of the quantitative intent.

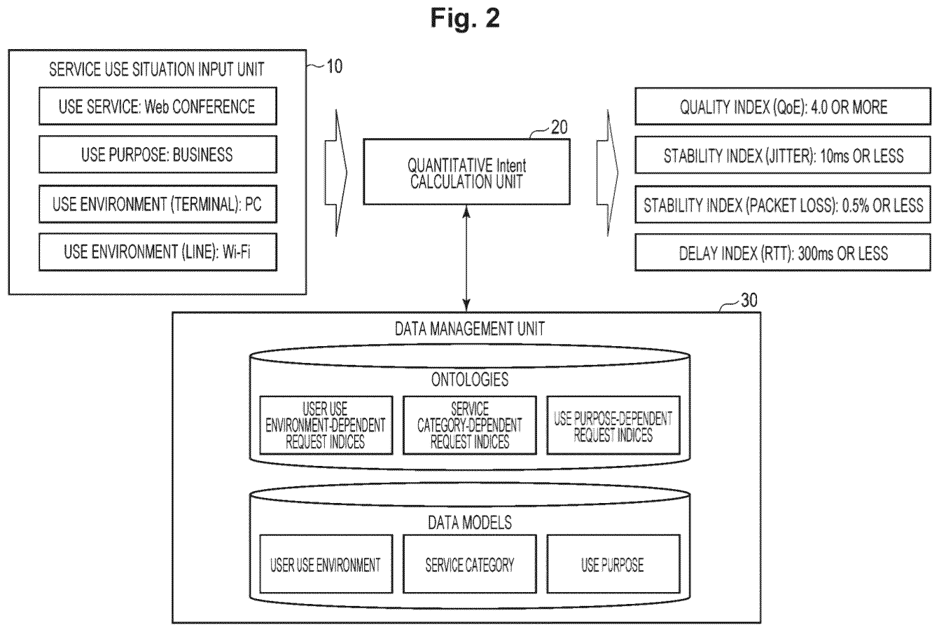

FIG. 2 is a diagram illustrating a specific example of information handled in each unit of the data processing apparatus according to the one embodiment of the present invention and a configuration of the data processing apparatus.

In the example illustrated in FIG. 2, the service use situation input unit 10 can receive, as a use situation of a service, inputs of information such as (a) to (d) below, which indicates (a) a name of the use service requested by a user (hereinafter, sometimes referred to as a use service name), (b) a service use purpose of the user (hereinafter, sometimes referred to as a use purpose), (c) the type of a service use environment of the user (hereinafter, sometimes referred to as a user use environment) (communication terminal) (hereinafter, sometimes referred to as a use environment (terminal)), and (d) the type of a service use environment of the user (communication line) (hereinafter, sometimes referred to as a use environment (line)).

(a) Use service: web conference

(b) Use purpose: business

(c) Use environment (terminal): personal computer (PC)

(d) Use environment (line): Wi-Fi

Other examples of the name of the use service include, for example, video on demand (VOD), remote control, and the like.

Other examples of the use purpose include, for example, private and the like.

Other examples of the type of the use environment (terminal) include, for example, a smart phone, a tablet, and the like.

Other examples of the use environment (line) include, for example, a fixed line (wired), a mobile line (4th generation (4G)) (also referred to as a 4G line), and the like.

As illustrated in FIG. 2, the storage device of the data management unit 30 stores data models and ontologies. The data models include a user use environment data definition model, a service category data definition model, and a use purpose data definition model.

The user environment data definition model defines, for example, a type of a service use environment (terminal) that can be selected by the user on an input screen of a user use environment as data that can be input to the service use situation input unit 10 by a user's operation. For example, the PC, the smart phone, the tablet, or the like is defined as the type of the service use environment (terminal). The user use environment data definition model also defines a type of a service use environment (line) that can be input. For example, the Wi-Fi, the fixed line (wired), the mobile line (4G), or the like is defined as the type of the service use environment (line).

The service category data definition model defines, for example, a name of a service that can be selected by the user on an input screen of a name of a service that the user desires to use data that can be input to the service use situation input unit 10 by a user's operation. For example, the web conference, the VOD, the remote control, or the like is defined as the name of the service.

Furthermore, the service category data definition model defines the name of the service and a category to which the service according to the name belongs (hereinafter, sometimes referred to as a service category). For example, “video/audio bidirectional distribution service”, which is a category to which the web conference belongs, is defined as the category to which the service according to the name belongs.

The use purpose data definition model defines, for example, a type of a use purpose of service that can be selected by the user on an input screen of a service use purpose as data that can be input to the service use situation input unit 10 by a user's operation. For example, the business or the private is defined as the type of the use purpose of the service.

The ontologies include an ontology of user use environment-dependent request indices, an ontology of service use purpose-dependent request indices, and an ontology of service category-dependent request indices.

The ontology of user use environment-dependent request indices define a type of a related index of a quantitative intent according to each type of the user use environment (terminal) defined in the user use environment data definition model.

The ontology of service category-dependent request indices defines a type of an index of a quantitative intent according to the type of the service defined in the service category data definition model. For example, a quality index (Quality of Experience (QoE)), a stability index (jitter), a stability index (packet loss), and a delay index (Round-Trip Time (RTT)) are defined as the type of the index of the quantitative intent.

The ontology of service use purpose-dependent request indices defines a type of an index of a quantitative intent according to the type of the service use purpose defined in the use purpose data definition model.

The various ontologies are ontologies each of which outputs a requirement related to provision of the service on the basis of the input service use situation, and are constructed such that output requirements related to provision of the service approach correct answer information.

The quantitative intent calculation unit 20 can calculate quantitative intents corresponding to the input contents by the service use situation input unit 10 on the basis of the input contents by the service use situation input unit 10 and the data models and the ontologies in the data management unit 30.

In the example illustrated in FIG. 2, the quantitative intents to be calculated are the following (a) to (d).
(a) Quality index (QoE): 4.0 or more
(b) stability index (jitter): 10 [ms] or less
(c) Stability index (packet loss): 0.5 [%] or less
(d) Delay index (RTT): 300 [ms] or less

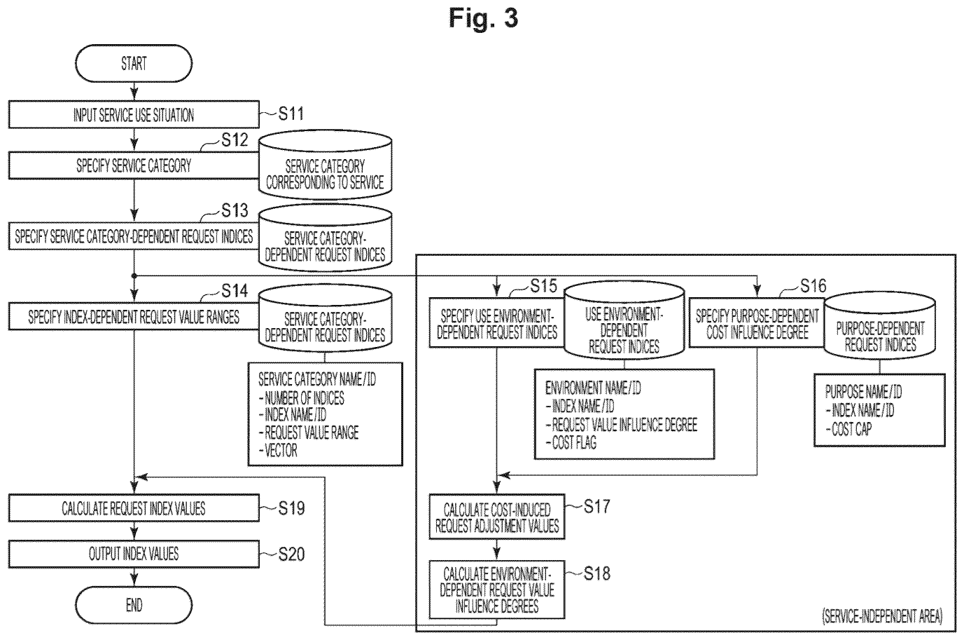

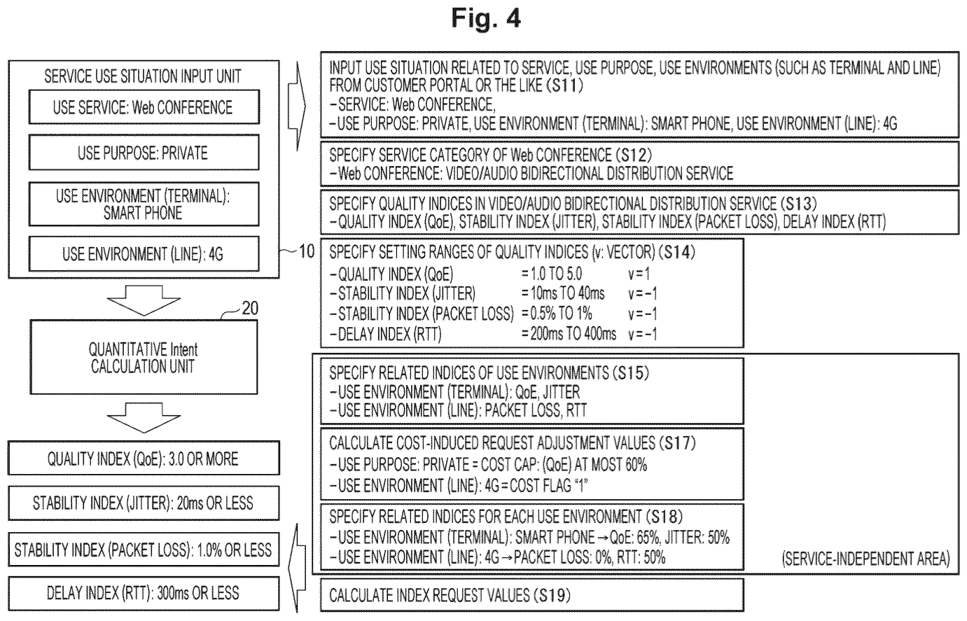

FIG. 3 is a diagram for describing an example of a procedure of processing by the data processing apparatus according to the embodiment of the present invention. FIG. 4 is a diagram illustrating an example of information handled in the processing by the data processing apparatus according to the one embodiment of the present invention.

First, the service use situation input unit 10 receives, as a use situation of a service, inputs of the type of the use service, the type of the use purpose, the use environment (terminal), and the type of the use environment (line) (S11).

Here, it is assumed that the following inputs (a) to (d) illustrated in FIG. 4 are received.
(a) Use service: web conference
(b) Use purpose: private
(c) Use environment (terminal): smart phone
(d) Use environment (line): mobile line (4G)

Next, the quantitative intent calculation unit 20 inputs the name of the use service input in S11 to the service category data definition model in the data management unit 30, and specifies a service category to which the name of the use service belongs from this model (S12). Here, it is assumed that the service category “video/audio bidirectional distribution service” to which the web conference belongs is specified.

Next, the quantitative intent calculation unit 20 reads the ontology of service category-dependent request indices in the data management unit 30, and uses the ontology to specify quality indices of the service to be provided to the user in the service category “video/audio bidirectional distribution service” specified in S12 (S13).

Here, it is assumed that the following (a) to (d) are specified as quality indices in the specified service category “video/audio bidirectional distribution service”.
(a) Quality index (QoE)
(b) Stability index (jitter)
(c) Stability index (packet loss)
(d) Delay Index (RTT)

Next, the quantitative intent calculation unit 20 reads the ontology of service category-dependent request indices in the data management 30, and uses the ontology to specify index-dependent request value ranges, which are setting ranges of the values of the quality indices specified in S13 (S14).

The index-dependent request value ranges may include the specified service category, identification information of the category, the number of indices, index names, identification information (identifiers (IDs)) of the index names, request value ranges, and vectors v. Each of the vectors indicates the relationship between the magnitude of the value of one of the specified quality indices and the quality.

For example, if a vector related to the value of a certain quality index is “1”, it means that the quality is better as the value of the quality index is larger, and if the vector is “−1”, it means that the quality is worse as the value of the quality index is larger.

Here, it is assumed that the following (a) to (d) are specified as setting ranges of the values of the quality indices in the specified service category “video/audio bidirectional distribution service”.
(a) Quality index (QoE)=1.0 to 5.0, v=1
(b) Stability index (jitter)=10 to 40 [ms], v=−1
(c) Stability index (packet loss)=0.5 to 1 [%], v=−1
(d) Delay index (RTT)=200 to 400 [ms], v=−1

Next, as processing related to service-independent area, the quantitative intent calculation unit 20 reads the ontology of use environment-dependent request indices in the data management unit 30, and uses the ontology to specify use environment-dependent request indices, which related indices of the use environments input in S11 and related to the quality indices specified in S13 (S15).

The use environment-dependent request indices may include names of the use environments, identification information of the names, names of the request indices, identification information of the names, degrees of influence on the specified quality indices, and cost flags. Each of the cost flags indicates whether a cost in one of the use environments in the use environment-dependent request indices has an influence on the values of the specified quality indices.

For example, if a cost flag related to a certain use environment is “1”, it means that a cost generated in this use environment has an influence on the values of the quality indices, and if the cost flag is “0”, it means that the cost has no influence on the values of the quality indices.

Here, the following indices (a) are specified as use environment-dependent request indices, which are related indices of the input use environment (terminal), and the following indices (b) are specified as use environment-dependent request indices, which are related indices of the input use environment (line).
(a) Use environment (terminal): QoE and jitter
(b) Use environment (line): packet loss and RTT

Next, as processing related to the service-independent area, the quantitative intent calculation unit 20 reads the ontology of purpose-independent request indices in the data management unit 30, and uses the ontology to specify a purpose-dependent cost influence degree, which is a related index of the use purpose input in S11 and related to the quality indices specified in S13 (S16).

The purpose-dependent cost influence degree may include a name of the use purpose, identification information of the name, a name of a request index, identification information of the name, and a cost cap (cap). This cost cap indicates a limit, that is, an upper limit value of a cost generated in the use purpose in the purpose-dependent cost influence degree to the value of the specified quality index.

Here, it is specified that the purpose-dependent cost influence degree related to the “use purpose: private” is “cost cap: QoE (at most 60 [%])”.

Next, as processing related to the service-independent area, the quantitative intent calculation unit 20 calculates cost-induced request adjustment values on the basis of the use environment-dependent request indices specified in S15 and the purpose-dependent cost influence degree specified in S16 (S17).

Here, the following (a) is calculated as a cost-induced request adjustment value on the basis of the purpose-dependent cost influence degree specified in S16, and the following (b) is calculated as a cost-induced request adjustment value on the basis of the use environment-dependent indices specified in S15.
(a) Use purpose: Private=Cost cap: QoE (at most 60 [%])
(b) Use environment (line): mobile line (4G)=cost flag “1”

Next, as processing related to the service-independent area, the quantitative intent calculation unit 20 calculates environment-dependent request value influence degrees on the basis of the use environment-dependent request indices specified in S15, the purpose-dependent cost influence degree specified in S16, and the cost-induced request adjustment values calculated in S17 (S18).

Here, the following (a) and (b) are calculated as environment-dependent request value influence degrees.
(a) Use environment (terminal): smart phone−>QoE: 65 [%], jitter: 30 [%]
(b) Use environment (line): mobile line (4G)−>packet loss: 0 [%], RTT: 50 [%]

Next, the quantitative intent calculation unit 20 calculates each request index value by multiplying the index-dependent request value ranges specified in S14 by the environment-dependent request value influence degrees calculated in S18 for each index (S19), outputs the calculation results to the automatic control system, and notifies the user of the calculation results using a display device (not illustrated) (S20).

Here, the following (a) to (d) are calculated as request index values.
(a) Quality index (QoE): 3.0 or more
(b) stability index (jitter): 20 [ms] or less
(c) Stability index (packet loss): 1.0 [%] or less
(d) Delay index (RTT): 300 [ms] or less

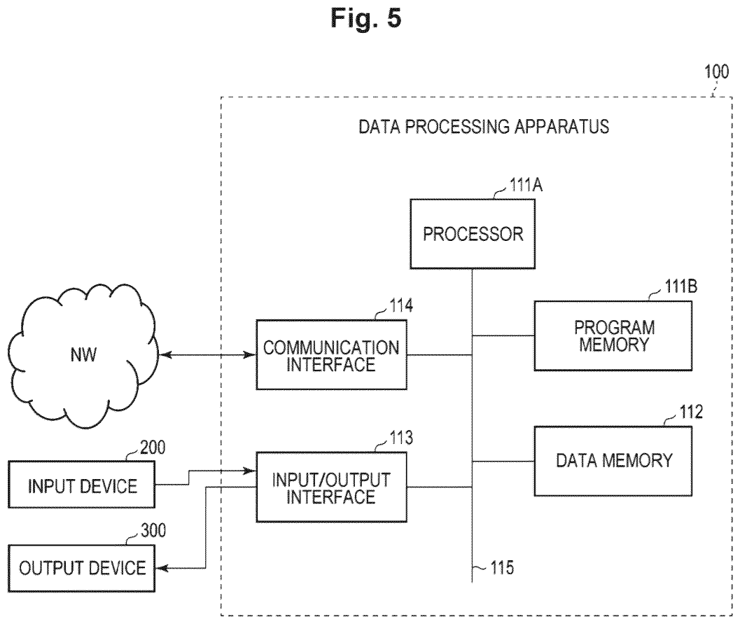

FIG. 5 is a block diagram illustrating an example of a hardware configuration of a data processing apparatus according to the one embodiment of the present invention.

In the example illustrated FIG. 5, the data processing apparatus 100 according to the embodiment is configured, for example, as a server computer or a personal computer, and includes a hardware processor 111A such as a central processing unit (CPU). In addition, the hardware processor 111A is connected to a program memory 111B, a data memory 112, an input/output interface 113, and a communication interface 114 via a bus 115.

The communication interface 114 includes, for example, one or more wireless communication interface units, and enables transmission and reception of information to and from communication network NW. As a wireless interface, for example, an interface is used in which a low-power wireless data communication standard such as a wireless local area network (LAN) is adopted.

The input/output interface 113 is connected to an input device 200 and an output device 300, which are attached to the data processing apparatus 100 and used by a user or like.

The input/output interface 113 performs processing of retrieving operation data input by the user or the like through the input device 200 such as a keyboard, a touch panel, a touchpad, or a mouse, and outputting output data to the output device 300 including a display device using liquid crystal, organic electro luminescence (EL), or the like to display the output data. Note that, as the input device 200 and the output device 300, devices built in the data processing apparatus 100 may be used, or an input device and an output device of another information terminal that can communicate with the data processing apparatus 100 via the network NW may be used.

The program memory 111B is used as a non-transitory tangible storage medium, for example, as a combination of a non-volatile memory on which writing and reading can be performed as necessary, such as a hard disk drive (HDD) a solid state drive (SSD) and a non-volatile memory such as a read only memory (ROM), and stores programs necessary for executing various types of control processing and the like according to the one embodiment.

The data memory 112 is used as a tangible storage medium, for example, as a combination of a non-volatile memory and a volatile memory such as random access memory (RAM), and is used to store various types of data acquired and created in a process in which various types of processing are performed.

The data processing apparatus 100 according to the one embodiment of the present invention can be configured as a data processing apparatus including the service use situation input unit 10 and the quantitative intent calculation unit 20 illustrated in FIG. 1 as processing function units by software.

Information storage units used as working memories or the like by the units of the data processing apparatus 100 and the data management unit 30 can be configured by use of the data memory 112 illustrated in FIG. 5. However, these configured storage areas are not essential in the data processing apparatus 100, and may be areas provided, for example, in an external storage medium such as a universal serial bus (USB) memory of a storage device such as a database server arranged in a cloud.

Each processing function unit in the units of the service use situation input unit 10 and the quantitative intent calculation unit 20 can be implemented by causing the hardware processor 111A to read and execute a program stored in the program memory 111B. Note that some or all of these processing function units may be implemented in other various forms including an integrated circuit such as an application specific integrated circuit (ASIC) or a field-programmable gate array (FPGA).

The data processing apparatus according to the one embodiment described above can calculate a quantitative intent that is a requirement of the quality of a service in consideration of a service use purpose and a use environment of a user by using data models defined in a distributed manner.

As a result, it is possible to provide the service in consideration of a direct request of the user without intervention of a service provider. In addition, the quantitative intent is calculated with data depending on the type of the service separated from data not depending on the type of the service, and thus it is possible to reduce the maintenance cost at the time of addition and change of a service and to secure the flexibility related to the addition and change of a service.

In addition, the method described in each embodiment can be stored aa a program (software means) that can be executed by a computing machine (computer), for example, in a recording medium such as a magnetic disk (such as a floppy (registered trademark) disk or a hard disk), an optical disc (such as a CD-ROM, a DVD, ox a MO), or a semiconductor memory (such as a ROM, a RAM, or a flash memory), and can be distributed by being transmitted through a communication medium. Note that the programs stored in the medium also include a setting program for configuring, in the computing machine a software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such magnetic disk or a semiconductor memory provided inside the computing machine or in a device connected via a network.

Note that the present invention is not limited to the above embodiment, and various modifications can be made in the implementation stage without departing from the gist of the invention. In addition, the embodiments may be implemented in appropriate combination, and in this case, a combined effect can be obtained. Furthermore, the above embodiment includes various inventions, and various inventions be extracted by a combination selected from a plurality of disclosed components. For example, in a case where the problem can be solved and the effects can be obtained even if some components are deleted from all the components described in the embodiment, a configuration from which the components are deleted can be extracted as an invention.

### REFERENCE SIGNS LIST

100 Data processing apparatus
10 Service use situation input unit
20 Quantitative intent calculation unit
30 Data management unit

1. A data processing apparatus comprising:
input circuitry that receives an input related to a situation when a user who uses a service uses the service;
a memory that stores information indicating a relationship between a situation when the service is used and a requirement related to provision of the service to the user; and
calculation circuitry that calculates a requirement related to provision of the service to the user on a basis of a result of input by the input circuitry and the information stored in the memory.

2. The data processing apparatus according to claim 1, wherein:
the situation when the service is used includes a type of the service, a purpose for which the user uses the service, and an environment when the user uses the service.

3. The data processing apparatus according to claim 2, wherein:
the environment when the service is used includes a type of a communication terminal device used by the user when the service is used and a type of a communication line used by the user when the service is used.

4. The data processing apparatus according to claim 2, wherein the calculation circuitry:
calculates a value of a requirement of the service on a basis of the type of the service among results of input by the input circuitry,
calculates an adjustment value of the value of the requirement of the service on a basis of the purpose for which the user uses the service and the environment when the user uses the service among the results of input by the input circuitry, and
calculates the requirement related to provision of the service to the user on a basis of the calculated value of the requirement of the service and the calculated adjustment value.

5. The data processing apparatus according to claim 1, wherein:
the information stored in the memory is an ontology that inputs a result of input by the input circuitry and outputs a requirement related to provision of the service to the user, and is constructed such that the output requirement related to provision of the service approaches correct answer information.

6. A data processing method performed by a data processing apparatus including a memory that stores information indicating a relationship between a situation when a user uses a service and a requirement related to provision of the service to the user who uses the service, the data processing method comprising:
receiving an input related to a situation when the user who uses the service uses the service; and
calculating a requirement related to provision of the service to the user on a basis of a result of the input and the information stored in the memory.

7. The data processing method according to claim 6, wherein:
the situation when the service is used includes a type of the service, a purpose for which the user uses the service, and an environment when the user uses the service.

8. A non-transitory computer-readable medium having computer-executable instructions that, upon execution of the instructions by a processor of a computer, cause the computer to perform the method of claim 6.
